(19) United States
(12) Patent Application Publication
(10) Pub. No.: US 2009/0106704 A1
(43) Pub. Date: Apr. 23, 2009

(54) METHOD, APPARATUS, AND CONSUMER PRODUCT FOR CREATING SHORTCUT TO INTERFACE ELEMENT

(75) Inventor: David DE LEON, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/874,568

(22) Filed: Oct. 18, 2007

(51) Int. Cl. G06F 3/048

(52) U.S. Cl. 715/847

(57) ABSTRACT

Embodiments disclosed herein may include creating a shortcut to an interface element, such as a graphical icon, located at first position on a display. Embodiments may include setting a bookmark at said interface element, connecting said bookmark to a bookmark dock that is located at a second position on the display, and connecting said bookmark dock to a mobile activator, so that activation of the mobile activator will constitute activation of the interface element.

### TECHNICAL FIELD

One or more embodiments disclosed herein may include a method for creating a shortcut to an interface element, such as a graphical icon, located at a first position on a display. One or more embodiments disclosed herein may also concern a computer program product, a consumer product, a system, and a digital home.

### BACKGROUND OF THE INVENTION

Interface elements, such as graphical icons, which may represent the information and/or actions that are available to a computer user, may be displayed on a computer's display screen. The information or action represented by an interface element is accessed by direct manipulation of the interface element using a designated device, such as a mouse and/or keyboard. For example, information and/or actions may be accessed by positioning a mouse cursor on an interface element and clicking a button on the mouse.

Shortcuts to interface elements are sometimes pre-programmed into a computer by a computer manufacturer/programmer. Computer keyboards or headsets may, for example, include designated hardware control buttons, the activation of which is the same as clicking on the interface element. Although such hardware control buttons are usually configurable to some extent, the types of pre-programmed shortcuts and the amount of pre-programmed shortcuts are determined by the computer manufacturer/programmer. Users may, however, want to create and use a shortcut that has not been foreseen by the manufacturer/programmer. Furthermore, if a user installs software on a computer, the software might not be compatible with the shortcut solutions that have been pre-programmed into the computer's operating system.

A computer may be used to control a group of home appliances in a digital home. Alternatively, a group of home appliances may be controlled using a universal remote control that is programmed to operate various brands of one or more types of home appliance. Some of the remote controls that are sold with a home appliance may include universal remote control capabilities for controlling other types of device, which may allow the remote control to control other devices, apart from the device it came with. For example, a remote control for a DVD-player may be programmed to operate various brands of television. Programming a universal remote control can, however, be a fairly complex procedure.

### SUMMARY OF THE INVENTION

According to a first aspect of one or more embodiments, a method for creating a shortcut to an interface element, such as a graphical icon, located at first position on a display, may include: setting a bookmark at said interface element, connecting said bookmark to a bookmark dock that is located at a second position on the display, and connecting said bookmark dock to an activator, so that activation of the activator will constitute activation of the interface element.

According to a second aspect of one or more embodiments, said activator of the method according to the first aspect may be a mobile activator.

According to a third aspect of one or more embodiments, the method according to the first or second aspect may include connecting said bookmark to said bookmark dock using a direct manipulation interaction paradigm, e.g., drag and drop.

According to a fourth aspect of one or more embodiments, the method according to any of the preceding aspects may include activating said marker by clicking an interface element displayed on the display, striking a tangent (e.g., key) on a keyboard, issuing a voice command, touching the display, or selecting the interface element that is to be marked using a device that is remote to said display.

According to a fifth aspect of one or more embodiments, said activator of the method according to any of the preceding aspects may be contained in a hand-held device, such as a mobile telephone or personal digital assistant (PDA).

According to a sixth aspect of one or more embodiments, the method according to any of the preceding aspects may include connecting a group of bookmarks to a single activator or connecting a single bookmark to a group of activators.

According to a seventh aspect of one or more embodiments, the method according to any of the preceding aspects may include arranging said bookmark dock to become visible, or pop up, on the display when a bookmark is connected thereto.

According to an eighth aspect of one or more embodiments, the method according to any of the preceding aspects may include arranging said bookmark dock to allow a user to input operation preferences and/or to select which activator(s) to connect a bookmark to.

According to a ninth aspect of one or more embodiments, the method according to any of the preceding aspects may include storing data concerning the activation of the bookmark.

According to a tenth aspect of one or more embodiments, the method according to the ninth aspect may include transmitting said data to one or more activators.

According to an eleventh aspect of one or more embodiments, a computer program product may include a computer program including instructions arranged to cause a computer or a processor to execute a method according to any of the preceding claims, stored on a computer-readable medium or a carrier wave.

According to a twelfth aspect of one or more embodiments, the consumer product, such as a mobile phone or a home appliance or household electrical entertainment appliance, may include a computer program product according to the eleventh aspect.

According to a thirteenth aspect of one or more embodiments, a system for creating a shortcut to an interface element, such as a graphical icon, located at first position on a display, may include: a display that is arranged to display an interface element, such as a graphic icon, at a first position on the display, and a marker that is arranged to allow a user to bookmark said interface element, wherein said system also comprises: a bookmark dock that is arranged to be located at a second position on the display, a first connection-establishing means that is arranged to connect said bookmark to said bookmark dock, activator that is arranged to allow a user to activate said interface element, and a second connection-establishing means that is arranged to connect said bookmark dock to said activator, so that activation of the activator will constitute activation of the interface element.

According to a fourteenth aspect of one or more embodiments, said activator according to the system of the thirteenth aspect may include a mobile activator.

According to a fifteenth aspect of one or more embodiments, said bookmark of the system of the thirteenth and fourteenth aspects may be arranged to be connected to said bookmark dock using a direct manipulation interaction paradigm, i.e. drag and drop.

A sixteenth aspect of one or more embodiments may include the system according to any of the thirteenth through fifteenth aspects, wherein said bookmark may be arranged to be activated by clicking an interface element displayed on the display, striking a tangent on a keyboard, issuing a voice command, touching the display, or selecting the interface element that is to be bookmarked using a remote device.

A seventeenth aspect of one or more embodiments may include the system according to any of the thirteenth through sixteenth aspects, wherein said activator contained in a hand-held or mobile device, such as a mobile telephone or personal digital assistant (PDA).

An eighteenth aspect of one or more embodiments may include the system according to any of the thirteenth through seventeenth aspects, wherein a group of bookmarks is arranged to be connected to a single activator or a single bookmark may be arranged to be connected to a group of activators.

A nineteenth aspect of one or more embodiments may include the system according to any of the thirteenth through eighteenth aspects, wherein said bookmark dock may be arranged to pop up on said display when a bookmark is connected thereto.

A twentieth aspect of one or more embodiments may include the system according to any of the thirteenth through nineteenth aspects, wherein the bookmark dock may be arranged to allow a user to input operation preferences and/or to select which activator(s) to connect a bookmark to.

According to a twenty-first aspect of one or more embodiments, the system according to any of the thirteenth through twentieth aspects may include storage means to store data concerning the activation of the bookmark.

According to a twenty-second aspect of one or more embodiments, the system according to the twenty-first aspect may include a transmitter to transmit said data to one or more activators.

According to a twenty-third aspect of one or more embodiments, a system according to any of the thirteenth through twenty-second aspects may include a computer program product according to the eleventh aspect, or at least one consumer product according to the twelfth aspect.

### BRIEF DESCRIPTION OF THE DRAWINGS

Embodiments will hereinafter be further explained by means of non-limiting examples with reference to the appended figures where;

FIGS. 1-3 schematically show an exemplary method being performed on a system according to an embodiment,

FIG. 4 schematically shows an exemplary digital home according to an embodiment, and

FIG. 5 is a flowchart of an exemplary process according to one embodiment.

The drawings have not been drawn to scale and that the dimensions of certain features have been exaggerated for the sake of clarity.

### DETAILED DESCRIPTION OF EMBODIMENTS

One or more embodiments disclosed herein may provide a fast and simple method for creating a shortcut to an interface element, such as a graphical icon, visual indicator, hyperlink, menu, window, text box, widget, or control, etc., located at a first position on a display, such as the display screen of a computer, a consumer product, or a control system.

The term “setting a bookmark” as used in this document means that the position of an interface element (such as a link to a web page) is marked in such a way that the user may activate that interface element at any time after the interface element has been bookmarked, even if the marker used for setting the bookmark (such as a mouse cursor) is moved away from the interface element after the interface element has been bookmarked. For example, if using a cursor to set a bookmark, the position of the cursor on the display may be stored so that the interface element at that position on the display may subsequently be activated by a user.

The term “bookmark dock” as used herein means a position on the display, whereby activating that position, for example by locating a mouse cursor at that position or dragging an interface element or a bookmarked interface element to that position, allows a user to access software that may be used to connect (e.g., associate) a bookmark to an activator. A bookmark dock may not necessarily be located at a fixed position on the display. It may, for example, be arranged to pop up at any random location on the display on request from a user or when a user bookmarks an interface element.

The term “display” is intended to mean any device for visual or tactile presentation of images (including text) acquired, stored, or transmitted in various forms. While most common displays are designed to present information dynamically in a visual medium, tactile displays, usually intended for the blind or visually impaired (and usually combined with sonic presentation), use mechanical parts to dynamically update a tactile image (usually of text) so that the image may be felt by the fingers. A display may, therefore, be an analog electronic display, such as a cathode ray tube (CRT), a digital electronic display, such as a liquid crystal display (LCD), a plasma display panel (PDP), a projector or a refreshable Braille display, for example.

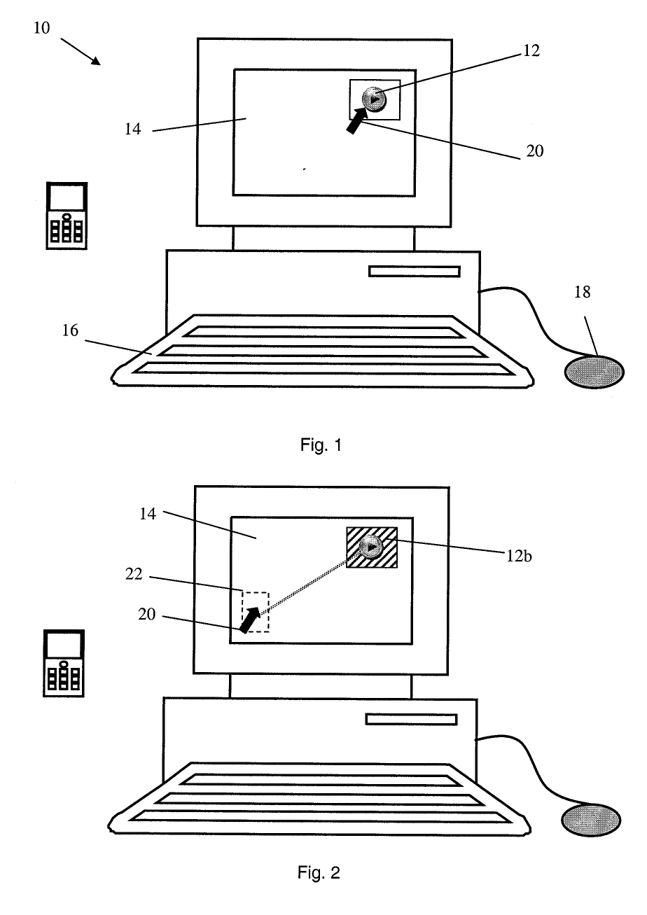

FIG. 1 shows an exemplary system 10 for creating a shortcut to an interface element 12, located at first position on the display screen 14 of a computer. The interface element 12 may, for example, be a control, such as a play/pause button, for an application that is embedded on a web page, such as a media player on the Pandora or Last FM website, or a video player on You Tube. The system 10 may include a marker, e.g., a keyboard 16 and a mouse 18, either, or both of which can be used to allow a user to bookmark the interface element 12. A user bookmarks the interface element 12 by positioning a cursor 20 at the position of the interface element 12 on the display screen 14, using the keyboard 16 and/or the mouse 18, and bookmarking that position, for example, by clicking a button on the mouse 18 or striking a tangent on the keyboard 16.

The computer of FIG. 1 may include a computer-readable medium (e.g., a read-only memory, a random-access memory, a hard disk drive, an optical drive, etc.) The computer may include a transmitter and/or a receiver to receive communications from activator 26.

FIG. 2 shows how the bookmarked interface element 12b may be connected (e.g., associated) to a second position 22 on the display screen 14 by clicking on the bookmarked interface element 12b and dragging it to said second position 22 on the display screen 14.

FIG. 3 shows that once a bookmarked interface element 12b has been dragged to and dropped at said second position 22 on the display screen 14, a graphical icon representing a bookmark dock 24 may pop up in said second position 22. A bookmark dock 24 may be arranged to allow a user to additionally input preferred settings, for example, a volume adjustor could be displayed to allow a user to adjust the volume of music being played, or the volume of music to be played.

The system may be able to determine/recognize that a particular interface element 12 may allow a user to input certain preferred settings. For example, this may, in one embodiment, be achieved by arranging a system to always display a particular interface element 12 (such as the on/off switch for a central heating system controlled by a computer whose screen displays an on/off icon) at a particular position on the display 14, whereby the bookmarking of that interface element 12 by the user would immediately cause a temperature scale to be displayed to allow a user to input a preferred temperature. The temperature could, for example, be adjusted by moving a graphic needle along the temperature scale using a cursor 20.

The bookmark dock 24 may be arranged to ask the user to confirm which activator or activators, he/she would like to use to activate the bookmarked interface element 12b. The bookmark dock 24 is then connected to the selected activator(s) 26 which may include the appropriate software to enable such a connection (e.g., association) to be made. When the user subsequently presses a designated button 28, on the selected activator 26, the bookmarked interface element 12b, which is located at the bookmarked position, is activated, e.g., the user may then control the play/pause button of the media player, located at the bookmarked position using the selected activator 26.

An activator may be any device having a group of functions, such as a mobile telephone or a Personal Digital Assistant, or a device having a single function, such as a remote control, that may be arranged solely to activate one or more bookmarked interface elements. The activator may include software that allows a connection to the bookmark dock to be made. Such a connection may be made using a transmitter and/or receive included in activator 26. Such a connection may be made using a communications protocol, such as Bluetooth or any conventional wired or wireless communication method. The activator 26 may include a computer-readable medium including a random-access memory, a read-only memory, a hard disk drive, an optical drive, etc.

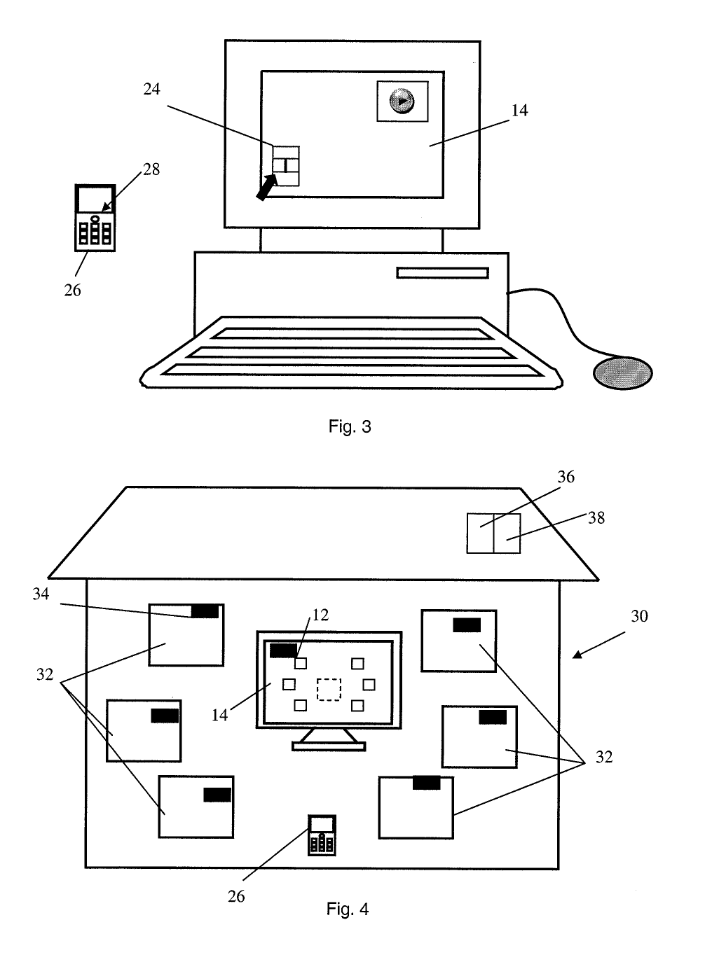

FIG. 4 schematically shows a digital home 30 that contains a group of consumer products 32, such as home appliances and household electrical entertainment appliances, which may be controlled using a system consistent with embodiments disclosed herein, which system may include a central display 14 that displays interface elements 12, such as graphical icons representing each of the consumer products 32, whereby any of the home appliances 32 may be controlled using the display 14. The central display 14 may be part of a consumer product 32, such as on a television or computer screen. Consumer products 32, the display 14, and the activator 26 may include software 34 that allows the consumer products 32 to be controlled using a method according to one or more embodiments.

By using the method according to one embodiment, a user may control any or all of the consumer products 32 using an activator 26, such as a mobile phone. The consumer products 32 in the digital home 30 may, therefore, be controlled from within the mobile home or from any location outside of the digital home.

By connecting (e.g., associating) a single bookmark to a group of activators 26, a group of users may control one consumer product 32 in the digital home 30. In such a case, the system according to one embodiment may include storage medium 36 to store data concerning the operation and/or status of each of the consumer products 32 and a transmitter 38 to transmit such data to any or all of the users, via display screens on activators 26, for example, so that any or all users are aware of the operation and/or status of any or all of the consumer products 32 in the digital home 30. A family member could, for example, be informed of whether anyone else in the family has turned on the central heating in the house and/or the temperature to which a central heating thermostat has been set.

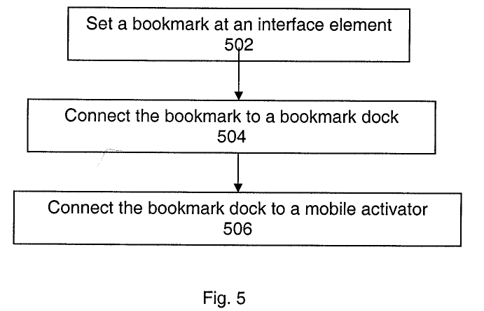

FIG. 5 is a flowchart of a process according to one embodiment. The process may include setting a bookmark at an interface element (block 502), such as the play/pause button on a media player control. The process may include connecting (e.g., associating) the bookmark to a bookmark dock (block 504) that is located at a second position on the display. The process may further include connecting (e.g., associating) the bookmark dock to an activator (block 504) so that activation of the activator will constitute activation of the interface element, e.g., whereby activation of the bookmarked interface element via the shortcut (by pressing a button on an activator, such as a mobile phone) may be the same as clicking on the bookmarked interface element.

The process of FIG. 5 may provide a user with a fast and simple method for creating a shortcut to an interface element located at a first position on a display and consequently may allow fast and simple access to application controls. Shortcuts may be created by a user on the fly, e.g., dynamically rather than as the result of something that is statically pre-defined. A user may not, therefore, be limited to using a constituent part of the device that may include the display, such as a mouse, keyboard or joystick, in order to control an application. The user may use any activator that may include software that allows the bookmark to be connected to the activator via the bookmark dock. Furthermore, a user can have several applications running simultaneously on the display and may not have to switch application in order to control a bookmarked application. The user can, for example, control the playback and sound volume of a media player application that is running in the background, while he/she is running another application.

The process may be used to connect a bookmarked interface element to a hardware key on the device including the display (such as a mouse key, keyboard tangent or joystick position) or a hardware key on some other mobile or immobile device. The process may include connecting the bookmarked interface element to the bookmark dock using a direct manipulation interaction paradigm, e.g., drag and drop, whereby a user may click on an interface element and drag it to the bookmark dock in order to connect the bookmarked interface element to the bookmark dock.

The process may include activating the marker by clicking an interface element displayed on the display, striking a tangent on a keyboard, issuing a voice command, touching the display, or selecting the interface element that is to be bookmarked using a device that is remote to the display.

The process may include connecting a group of bookmarks to a single activator. Alternatively, a group of bookmarks may be connected to a group of activators or a single bookmark may be connected to a group of activators. The process may include arranging the bookmark dock to become visible, or pop up, on the display when a bookmark is being set or being connected thereto. The process may include arranging the bookmark dock to allow a user to input operation preferences and/or to select which activator(s) to connect a bookmark to. The process may include storing data concerning the activation of the bookmark, such as data concerning if/when a bookmark was activated. The process may include transmitting such data to one or more activators.

Furthermore, one or more embodiments may concern a system for creating a shortcut to an interface element, such as a graphical icon, visual indicator, hyperlink, menu, window, text box, widget or control, located at first position on a display. The system may include a display that is arranged to display an interface element at a first position on the display, and a marker that is arranged to allow a user to bookmark the interface element. The system also may include a bookmark dock that is arranged to be located at a second position on the display and a first connection-establishing means that is arranged to connect the bookmark to the bookmark dock. The system further may include an activator that is arranged to allow a user to activate the interface element, and a second connection-establishing means that is arranged to connect the bookmark dock to the activator, so that activation of the activator will constitute activation of the interface element.

The activator may include a mobile activator, e.g., a device that is movable with respect to the display and which may optionally not be a part of the device that includes the display (e.g., the mobile activator is not a keyboard, mouse or joystick of the device including the display). The activator may be contained in a hand-held device, such as a mobile telephone or personal digital assistant (PDA).

The bookmark may be arranged to be connected to the bookmark dock using a direct manipulation interaction paradigm, e.g., drag and drop. The marker may be arranged to be activated by clicking an interface element displayed on the display, striking a tangent on a keyboard, issuing a voice command, touching the display, or selecting the interface element that is to be bookmarked using a remote device. Alternatively, a group of bookmarks may be connected to a group of activators or a single bookmark may be connected to a group of activators. A group of bookmarks may be arranged to be connected to a single activator or a single bookmark is arranged to be connected to a group of activators. The bookmark dock may be arranged to become visible, or pop up, on the display when a bookmark is connected thereto.

The bookmark dock may be arranged to allow a user to input operation preferences and/or to select which activator(s) to connect a bookmark to. The system may include storage media to store data concerning the activation of the bookmark, such as data concerning if/when a bookmark was activated. The system may include a transmitter to transmit such data to one or more activators.

One or more embodiments may also concern a computer program product that may include a computer program including instructions arranged to cause a computer or a processor to execute a method according to any of the embodiments, stored on a computer-readable medium or a carrier wave.

One or more embodiments may further concern a consumer product, such as a home appliance or household electrical entertainment appliance that may include such a computer program product. Embodiments disclosed herein may be applicable for use with any home appliance, e.g., any electrical/mechanical appliance that accomplishes some household function, such as cooking, cleaning or food preservation, e.g., an appliance such as a refrigerator, microwave oven, washing machine etc, or any household electrical entertainment appliance, such as a television, CD- or DVD-player etc.

One ore more embodiments disclosed may also concern a digital home that may include a system, a computer program product or at least one consumer product according to any of the embodiments.

The term “comprises/comprising” when used in this specification or claims is taken to specify the presence of stated features, integers, steps or components but does not preclude the presence or addition of one or more other features, integers, steps, components or groups thereof.

Further modifications of the invention within the scope of the claims would be apparent to a skilled person. For example, a bookmark could be set and connected to a bookmark dock using the activator itself.

1. A method for creating a shortcut to an interface element, such as a graphical icon, located at first position on a display, wherein the method comprises:
setting a bookmark at said interface element,
connecting said bookmark to a bookmark dock that is located at a second position on the display, and
connecting said bookmark dock to an activator, so that activation of the activator will constitute activation of the interface element.

2. The method of claim 1, wherein said activator is a mobile activator.

3. The method of claim 1, further comprising connecting said bookmark to said bookmark dock using a direct manipulation interaction paradigm or a drag and drop operation.

4. The method of claim 3, further comprising activating a marker by clicking an interface element displayed on the display, striking a tangent on a keyboard, issuing a voice command, touching the display, or selecting the interface element that is to be bookmarked using a device that is remote to said display.

5. The method of claim 1, wherein said activator comprises one or more of a hand-held device, a mobile telephone, or personal digital assistant (PDA).

6. The method of claim 1, further comprising connecting a plurality of bookmarks to a single activator or connecting a single bookmark to a plurality of activators.

7. The method of claim 6, further comprising arranging said bookmark dock to become visible or pop up on the display when a bookmark is connected thereto.

8. The method of claim 7, further comprising arranging said bookmark dock to allow a user to input operation preferences and/or to select which activator(s) to connect a bookmark to.

9. The method of claim 8, further comprising storing data concerning the activation of the bookmark.

10. The method of claim 9, wherein it comprises transmitting said data to one or more activators.

11. A system for creating a shortcut to an interface element, such as a graphical icon, located at first position on a display, comprising:
a display that is arranged to display an interface element, such as a graphic icon, at a first position on the display, and
a marker that is arranged to allow a user to bookmark said interface element,
wherein said system also comprises:
a bookmark dock that is arranged to be located at a second position on the display,
a first connection-establishing user interface that is arranged to connect said bookmark to said bookmark dock,
activator that is arranged to allow a user to activate said interface element, and
a second connection-establishing user interface that is arranged to connect said bookmark dock to said activator, so that activation of the activator will constitute activation of the interface element.

12. The system of claim 11, wherein said activator is a mobile activator.

13. The system of claim 11, wherein said bookmark is arranged to be connected to said bookmark dock using one or more of a direct manipulation interaction paradigm or a drag and drop operation.

14. The system of claim 13, wherein said marker is arranged to be activated by clicking an interface element displayed on the display, striking a tangent on a keyboard, issuing a voice command, touching the display, or selecting the interface element that is to be bookmarked using a remote device.

15. The system of claim 11, wherein said activator comprises one or more of a hand-held or mobile device, a mobile telephone, or personal digital assistant (PDA).

16. The system of claim 15, wherein a plurality of bookmarks is arranged to be connected to a single activator or a single bookmark is arranged to be connected to a plurality of activators.

17. The system of claim 16, wherein said bookmark dock is arranged to pop up on said display when a bookmark is connected thereto.

18. The system of claim 17, wherein the bookmark dock is arranged to allow a user to input operation preferences and/or to select which activator(s) to connect a bookmark to.

19. The system of claim 18, further comprising a storage medium to store data concerning the activation of the bookmark.

20. The system of claim 19, further comprising a transmitter to transmit said data to one or more activators.

21. A computer-readable medium including instructions executable by at least one processor, the computer-readable medium comprising:
one or more instructions for setting a bookmark at said interface element,
one or more instructions for connecting said bookmark to a bookmark dock that is located at a second position on the display, and
one or more instructions for connecting said bookmark dock to an activator, so that activation of the activator will constitute activation of the interface element.

22. The computer-readable medium of claim 21, further comprising instructions for activating a marker based on information received from a clicking of an interface element displayed on the display, a striking of a tangent on a keyboard, an issuance of a voice command, a touching the display, or a selection of the interface element that is to be bookmarked using a device that is remote to said display.

23. The computer-readable medium of claim 21, further comprising one or more instructions for connecting said bookmark to said bookmark dock using a direct manipulation interaction paradigm or a drag and drop.

24. The computer-readable medium of claim 23, further comprising one or more instructions for connecting a plurality of bookmarks to a single activator or connecting a single bookmark to a plurality of activators.

25. The computer-readable medium of claim 23, further comprising one or more instructions for arranging said bookmark dock to become visible or pop up on the display when a bookmark is connected thereto.
